(19) United States
(12) Patent Application Publication
(10) Pub. No.: US 2011/0121531 A1
(43) Pub. Date: May 26, 2011

(54) Tie rod for wheel suspension of a vehicle

(75) Inventor: Bernhard Neuss, Wachtberg (DE)

(73) Assignee: ZF Friedrichshafen AG, Friedrichshafen (DE)

(21) Appl. No.: 10/926,568

(22) Filed: Aug. 26, 2004

(30) Foreign Application Priority Data
Sep. 5, 2003 (DE) DE 103 40 956.4

(51) Int. Cl. B62D 7/20

(52) U.S. Cl. 280/93.51

(57) ABSTRACT

Tie rod for the wheel suspension of a vehicle with a tie rod and at least one bearing bushing arranged in the tie rod, wherein the bearing bushing can be connected with the wheel suspension. The bearing bushing is provided with a support element which has an end region spaced from the bearing bushing that is supported on the tie rod.

### BACKGROUND OF THE INVENTION

1) Field of the Invention

The invention relates to a tie rod for a wheel suspension of a vehicle, which includes a tie rod and at least one bearing bushing that can be connected with the wheel suspension arranged in the tie rod.

2) Description of the Related Art

Tie rods for vehicles are known (DE 37 07 155 A1), wherein the tie rod of the suspension for a vehicle is provided with bearing bushings. The bearings hereby include of an outer tube, an inner tube and an interposed elastomer. This can disadvantageously cause acoustic vibrations, whereby the dynamic stiffness of the bearing bushing is achieved by a harder mixture of the elastomer and/or a mixture with enhanced damping. Harder rubber mixtures result in an inadequate damping and/or an insufficient dynamic stiffness. These disadvantages manifest themselves in particular with tie rods made of sheet metal.

It is therefore an object of the invention to provide a tie rod for a wheel suspension of a vehicle that suppresses acoustic vibrations or does not transmit acoustic vibrations to the adjacent components of the wheel suspension of a vehicle.

### BRIEF SUMMARY OR THE INVENTION

The object is solved by the invention in that the tie rod has a support element with an end region that is spaced apart from the bearing bushing and supported on the tie rod.

Advantageously, the vibrations are therefore damped in the tie rod itself and not in the bearing bushing.

Advantageously, the support element is rigidly connected with the bearing bushing.

According to another advantageous embodiment, the support element is provided with a damping element arranged between the end region and the tie rod. Advantageously, the suppression and/or the characteristic resonance of the vibrations are reduced by the damping element arranged between the tie rod in the support element, or shifted to advantageous frequency ranges.

According to another important feature, a conventional bushing made of an outer tube, and inner tube and an interposed rubber-elastic elastomer is provided as the bearing bushing. Alternatively, a hydraulically damping bushing, made of an outer tube, an inner tube and an interposed elastic rubber elastomer, is provided as the bearing bushing, wherein at least two chambers that are filled with a damping fluid and connected with each other by a throttle connection are arranged in the elastic rubber elastomer.

According to another advantageous embodiment, the support element is rigidly connected with the outer tube. In this way, a one piece assembly can be provided, which reduces a corresponding number of components.

According to another embodiment, the support element is arranged so as to extend parallel to the tie rod.

In another advantageous embodiment that can be easily manufactured, the damping element is affixed to the support element.

In addition, the tie rod includes at least two bearing bushings, wherein at least two of the bearing bushings have each at least one support element.

Accordingly and in summary, the invention provides a tie rod for a wheel suspension of a vehicle, which includes a tie rod and at least one bearing bushing arranged in the tie rod, wherein the bearing bushing can be connected with the wheel suspension, and wherein the tie rod has a support element with an end region that is spaced apart from the bearing bushing and supported on the tie rod. The support element may be rigidly connected with the bearing bushing. The support element is provided with a damping element arranged between the end region and the tie rod. A conventional bushing including an outer tube and an inner tube and an interposed rubber-elastic elastomer is provided as the bearing bushing. A hydraulically damping bushing, including an outer tube, an inner tube and an interposed rubber-elastic elastomer, is provided as the bearing bushing, and at least two chambers filled with a damping fluid are connected with each other by a throttle connection are arranged in the rubber-elastic elastomer. The support element is rigidly connected with the outer tube. The support element may also be arranged so as to extend parallel to the tie rod. The damping element may be affixed to the support element. The tie rod includes at least two bearing bushings, of which at least two bearing bushings have each at least one support element.

### BRIEF DESCRIPTION OF THE SEVERAL VIEWS OF THE DRAWING(S)

Advantageous embodiments of the invention are schematically illustrated in the drawings.

It is shown in:

FIG. 1 a top view of a tie rod;

FIG. 2 a side view of a tie rod together with the support element;

FIG. 3 a perspective view of the tie rod shown in FIG. 2 with the support element.

### DETAILED DESCRIPTION OF THE INVENTION

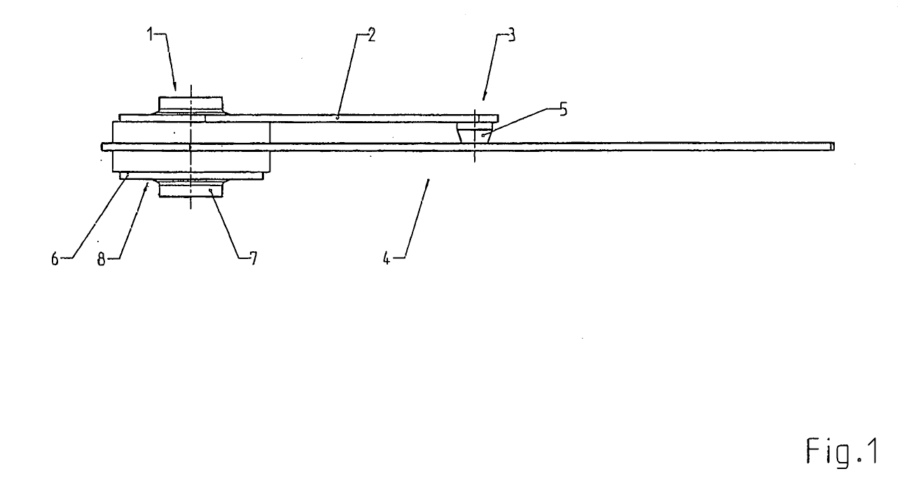

The tie rod 4 illustrated in FIG. 1 includes a bearing bushing 1 with an outer tube 6 that is received in a corresponding recess of the tie rod 4. For example, the outer tube 6 can be connected with the tie rod 4 by a press fit.

The bearing bushing 1 received in the tie rod 4 is essentially made of the outer tube 6, an inner tube 7 and an interposed elastomer 8. However, in another embodiment, at least two chambers can be arranged inside the elastomer 8 which are filled with a damping fluid and are connected with each other by a throttle connection. In this way, depending on the arrangement of the chambers, the chambers that are filled with the damping fluid can provide different damping characteristics.

The bearing bushing 1 of the tie rod 4 depicted in FIG. 1 is connected with a support element 2, whereby the support element 2 has an end region 3 that includes a damping element 5. The damping element 5 is supported on the tie rod 4, so that vibrations are damped not by the bearing bushing 1, but instead on the tie rod itself.

The damping element 5 is attached to the support element 2 and supported by the tie rod 4.

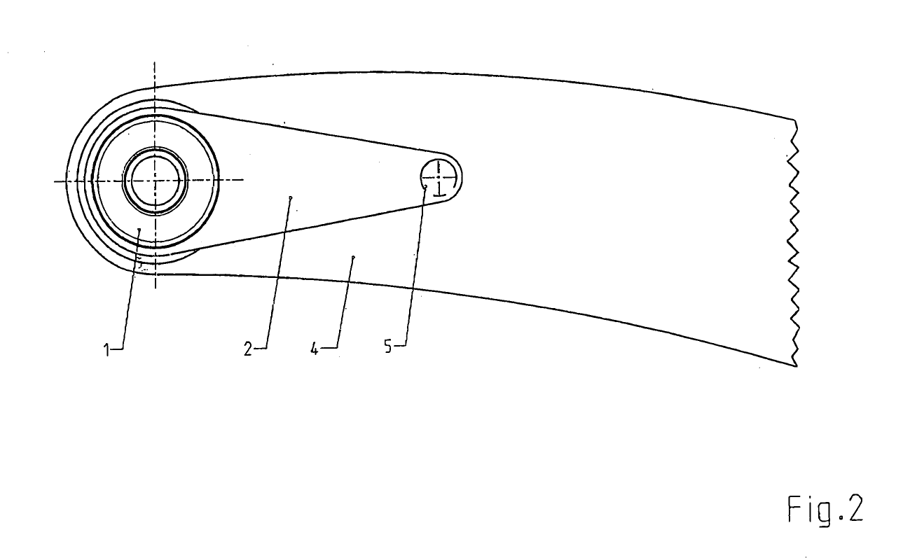

FIG. 2 shows a side view of the tie rod 4, whereby the bearing bushing is connected with the support element 2, and the damping element 5 is used to support the support element 2 on the tie rod 4.

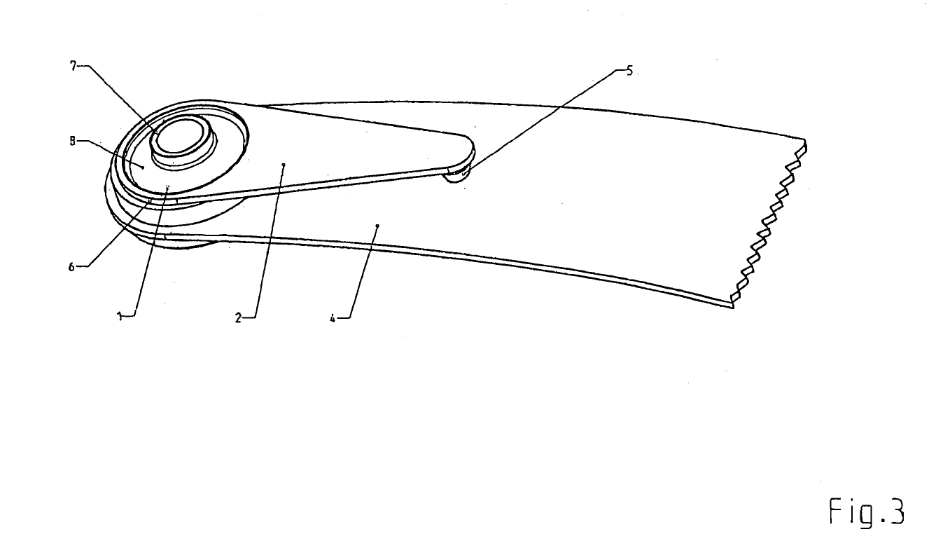

FIG. 3 shows a perspective view of the tie rod 4, whereby the support element 2 is used to hold the support element 2 in relation to the tie rod 4 through the bearing bushing 1 and the damping element 5.

The bearing bushing 1 is provided with an outer tube 6, an inner tube 7 and an interposed elastomer 8. The outer tube 6 of the bearing bushing 1 and the support element 2 can be made as a single piece or can be rigidly, but non-releasably connected with each other.

1. A tie rod for a wheel suspension of a vehicle, comprising
a tie rod and
at least one bearing bushing arranged in the tie rod,
wherein the bearing bushing can be connected with the wheel suspension,
wherein the tie rod (4) has a support element (2) with an end region (3) that is spaced apart from the bearing bushing (1) and supported on the tie rod (4).

2. The tie rod according to claim 1, wherein the support element (2) is rigidly connected with the bearing bushing (1).

3. The tie rod according to claim 1, wherein the support element (2) is provided with a damping element (5) arranged between the end region (3) and the tie rod (4).

4. The tie rod according to claim 1, wherein a conventional bushing comprising an outer tube (6), and inner tube (7) and an interposed rubber-elastic elastomer (8) is provided as the bearing bushing (1).

5. The tie rod according to claim 1, wherein a hydraulically damping bushing, comprising an outer tube (6), an inner tube (7) and an interposed rubber-elastic elastomer (8), is provided as the bearing bushing (1), and wherein at least two chambers that are filled with a damping fluid and connected with each other by a throttle connection are arranged in the rubber-elastic elastomer.

6. The tie rod according to claim 4, wherein the support element (2) is rigidly connected with the outer tube (6).

7. The tie rod according to claim 5, wherein the support element (2) is rigidly connected with the outer tube (6).

8. The tie rod according to claim 1, wherein the support element (2) is arranged so as to extend parallel to the tie rod (4).

9. The tie rod according to claim 3, wherein the damping element (5) is affixed to the support element (2).

10. The tie rod according to claim 1, wherein the tie rod (4) includes at least two bearing bushings (1), of which at least two bearing bushings (1) have each at least one support element (2).
